(19) United States
(12) Patent Application Publication
(10) Pub. No.: US 2012/0092147 A1
(43) Pub. Date: Apr. 19, 2012

(54) ELECTRONIC DEVICE WITH AUTOMATIC NOTIFICATION FUNCTION FOR PERSONAL EMERGENCY AND METHOD THEREOF

(75) Inventors: YING-CHUAN YU, Tu-Cheng (TW); PING-YANG CHUANG, Tu-Cheng (TW)

(73) Assignee: HON HAI PRECISION INDUSTRY CO., LTD., Tu-Cheng (TW)

(21) Appl. No.: 12/980,307

(22) Filed: Dec. 28, 2010

(30) Foreign Application Priority Data
Oct. 14, 2010 (TW) 99135131

(51) Int. Cl. B60Q 1/00

(52) U.S. Cl. 340/436

(57) ABSTRACT

An electronic device having an automatic notification function for a personal emergency is provided. The electronic device includes a position unit, a storage unit, a collision sensing unit, a processing unit, and a communications unit. The position unit provides locating information of the electronic device using longitude and latitude. The storage unit stores an emergency message, communication information, and the locating information of the electronic device. The collision sensing unit senses whether an acceleration according to certain predetermined collision parameters is experienced by the electronic device. The processing unit acquires the locating information of the electronic device and the emergency message from the storage unit, and edits the emergency message with the acquired locating information to generate a notification when the collision parameters of the electronic device occur. The communications unit delivers the notification according the communication information.

### BACKGROUND

1. Technical Field

The present disclosure relates to electronic devices and, particularly, to an electronic device that can automatically notify emergency responders in a personal emergency and a method thereof.

2. Description of Related Art

In general, time is critical when drivers are injured in accidents. A period of time known as the golden hour can quickly slip away if needed help is not received.

### BRIEF DESCRIPTION OF THE DRAWINGS

FIG. 1 is a block diagram of a hardware infrastructure of a system with an automatic notification function for a personal emergency in accordance with an exemplary embodiment.

FIG. 2 is a block diagram of a hardware infrastructure of a system with an automatic notification function for a personal emergency in accordance with another embodiment.

FIG. 3 is a flowchart of a method having an automatic notification function for a personal emergency implemented by the system of FIG. 1 in accordance with an exemplary embodiment.

### DETAILED DESCRIPTION

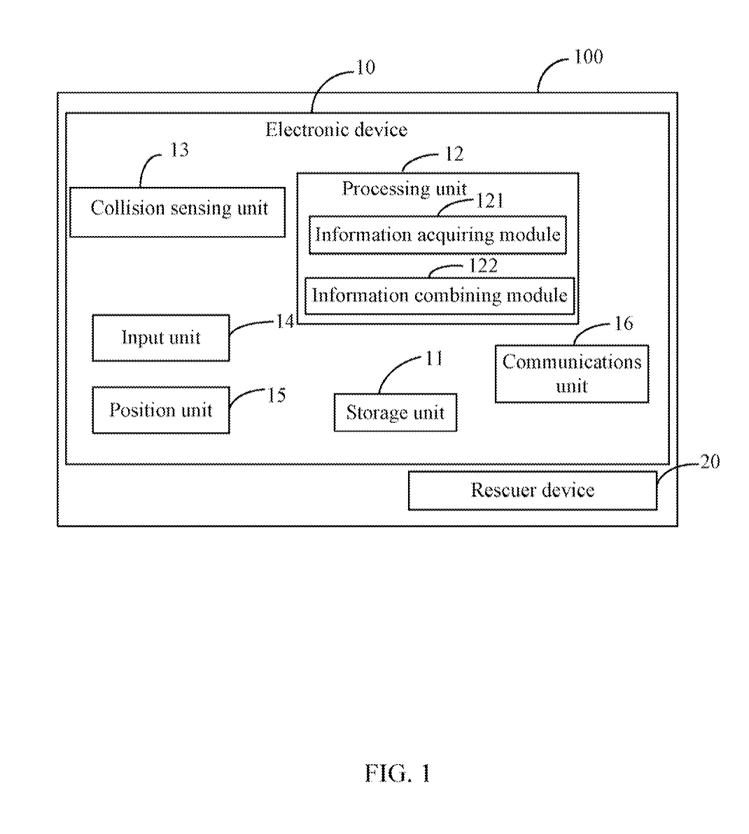

Referring to FIG. 1, a system 100 with an automatic notification function for a personal emergency is provided. The system 100 includes an electronic device 10 and at least one rescuer device 20. The device 10 is for automatically collecting data to generate a notification when users become a victim of an accident, and delivering the notification to the rescuer device 20 for obtaining help. The device 10 may be a wearable electronic device, portable electronic device, or a device which can be mounted on a motor vehicle or work station. The rescuer device 20 may be an electronic device such as, a mobile phone, a PDA etc., which can receive any messages sent by the device 10.

The device 10 includes a storage unit 11, an input unit 14, a processing unit 12, a collision sensing unit 13, a position unit 15, and a communications unit 16. The input unit 14 may be used call up and edit (personalize) a predetermined emergency message template to form an emergency message that can be automatically accessed when the device 10 is apparently involved in an accident. The communications unit 16 can transmit the emergency message to the rescuer device 20 according to a user input and pre-programmed communication information of the device 20, such as the phone number of the device 20 and/or email address of an account monitored by the device 20 upon occurrence of an accident. The position unit 15 is for providing locating information of the device 10 using longitude and latitude. In one embodiment, the position unit 15 may be a global positioning system (GPS) or an assisted global positioning system (AGPS). In other embodiments, the position unit 15 may be some other positioning system which can provide the longitude and latitude of the locating information of the device 10. The storage unit 11 is for storing the emergency message, the communication information of the rescuer device 20 and the locating information of the device 10.

The collision sensing unit 13 is for sensing whether acceleration according to certain predetermined collision parameters is experienced by the device 10. In one embodiment, the collision sensing unit 13 may be a three axis acceleration sensor or a two axis acceleration sensor, etc.

The processing unit 12 includes an information acquiring module 121 and an information combining module 122. The information acquiring module 121 is for acquiring the locating information of the device 10 and the emergency message from the storage unit 11 when the collision parameters of the device 10 occur. The information combining module 122 is for generating the notification by editing the emergency message with the acquired locating information. For example, the content of the notification may be: “This is John, I have been in an accident at 113°46′ and 22°27′ please send help!” In one embodiment, the format of the notification may be text, video, voice, etc. The notification may, in addition to or instead of longitude and latitude, include a nearby landmark where the accident has occurred. The communications unit 16 delivers the notification to other rescuer devices 20 by using a peer-to-peer technology.

The rescuer device 20 is for receiving the notification from the device 10, and allowing rescuer personnel to determine the position of the user of the device 10 according to the content of the notification.

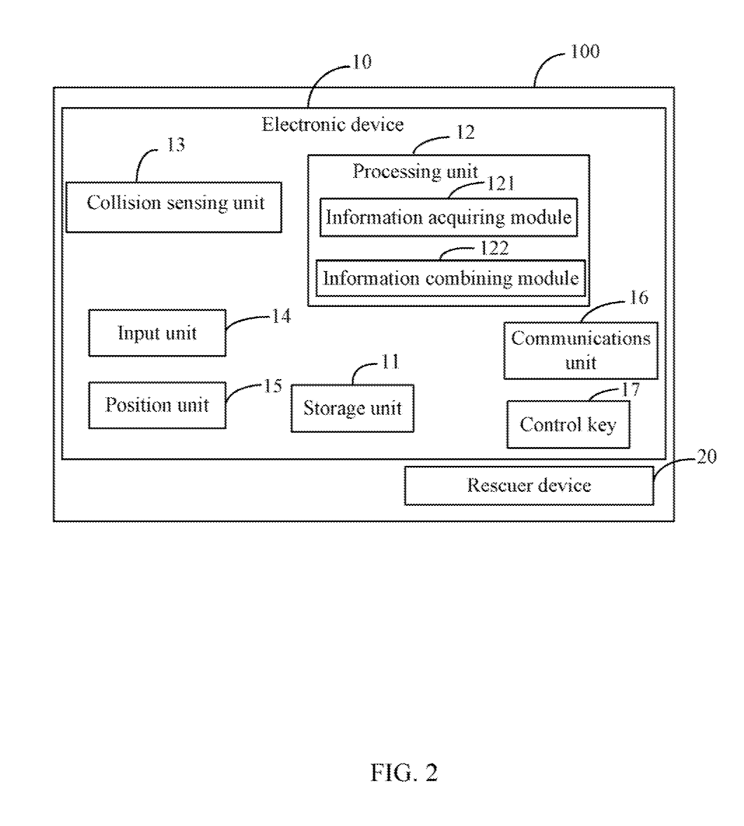

As shown in FIG. 2, in another embodiment, the device 10 further includes a control key 17 which is used for generating a control instruction in response to the user input. The processing unit 12 edits the emergency message with the acquired the locating information of the device 10 to generate the notification, and controls the communications unit 16 to deliver the notification to the rescuer device 20 in response to the control instruction from the control key 17.

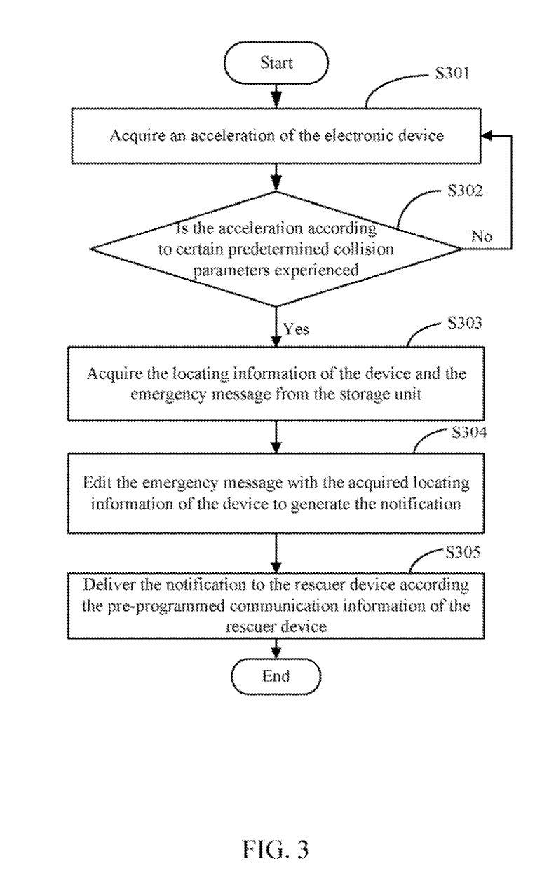

FIG. 3 is a flowchart of a method having an automatic notification function for a personal emergency implemented by the system in accordance with an exemplary embodiment.

In step S301, the collision sensing unit 13 acquires the acceleration of the device 10.

In step S302, the collision sensing unit 13 senses whether the acceleration according to the certain predetermined collision parameters is experienced by the device 10, if yes, the procedure goes to S303, if no, the procedure goes to S301.

In step S303, the information acquiring module 121 acquires the locating information of the device 10 and the emergency message from the storage unit 11.

In step S304, the information combining module 122 edits the emergency message with the acquired locating information of the device 10 to generate the notification.

In step S305, the communications unit 16 delivers the notification to the rescuer device 20 according the pre-programmed communication information of the rescuer device 20.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic device having an automatic notification function for a personal emergency, comprising:
a position unit for providing locating information of the electronic device using longitude and latitude;
a storage unit for storing an emergency message, communication information, and the locating information of the electronic device;
a collision sensing unit for sensing whether an acceleration according to certain predetermined collision parameters is experienced by the electronic device;
a processing unit for acquiring the locating information of the electronic device and the emergency message from the storage unit, and editing the emergency message with the acquired locating information to generate a notification when the collision parameters of the electronic device occur; and
a communications unit for delivering the notification to a rescuer device according the communication information.

2. The electronic device as described in claim 1, wherein the collision sensing unit is a three axis acceleration sensor.

3. The electronic device as described in claim 1, wherein the collision sensing unit is a two axis acceleration sensor.

4. The electronic device as described in claim 1, further comprising a control key which is used for generating a control instruction in response to an user input, wherein the processing unit acquires the locating information of the electronic device and the emergency message from the storage unit, edits the emergency message with the acquired locating information of the device to generate the notification, and controls the communications unit to deliver the notification to the rescuer device in response to the control instruction from the control key.

5. The electronic device as described in claim 1, wherein the position unit is a global positioning system or an assisted global positioning system.

6. The electronic device as described in claim 1, wherein the position unit is a combination of a global positioning system and an assisted global positioning system.

7. The electronic device as described in claim 1, wherein the communications unit delivers the notification to the rescuer device by using a peer-to-peer technology.

8. The electronic device as described in claim 1, further comprising:
an input unit used for editing the emergency message.

9. An electronic device having an automatic notification function for a personal emergency, comprising:
a position unit for providing locating information of the electronic device using longitude and latitude;
a storage unit for storing an emergency message, communication information, and the locating information of the electronic device;
a control key for generating a control instruction in response to an user input;
a processing unit for acquiring the locating information of the electronic device and the emergency message from the storage unit, editing the emergency message with the acquired locating information of the device to generate the notification; and
a communications unit for delivering the notification according the communication information in response to the control instruction.

10. A method having an automatic notification function for a personal emergency implemented by an electronic device, wherein the electronic device comprises a position unit and a storage unit, the position unit is for providing locating information of the electronic device using longitude and latitude, and the storage unit is for storing an emergency message, communication information, and the locating information of the electronic device, the method comprising:
sensing whether an acceleration according to certain predetermined collision parameters is experienced by the electronic device;
acquiring the locating information of the electronic device and the emergency message from the storage unit, and editing the emergency message with the acquired locating information to generate a notification when the collision parameters of the electronic device occur; and
delivering the notification according the communication information.

11. A method having an automatic notification function for a personal emergency implemented by an electronic device, wherein the electronic device comprises a position unit and a storage unit, the position unit is for providing locating information of the electronic device using longitude and latitude, and the storage unit is for storing an emergency message, communication information, and the locating information of the electronic device, the method comprising:
generating a control instruction in response to an user input;
acquiring the locating information of the electronic device and the emergency message from the storage unit, editing the emergency message with the acquired locating information of the electronic device to generate the notification; and
delivering the notification according the communication information in response to the control instruction.
